(19) United States
(12) Patent Application Publication
(10) Pub. No.: US 2016/0099584 A1
(43) Pub. Date: Apr. 7, 2016

(54) ELECTRONIC APPARATUS AND CONTROLLING METHOD THEREOF

(71) Applicant: SAMSUNG ELECTRONICS CO., LTD., Suwon-si (KR)

(72) Inventors: Jeong-kee PARK, Seongnam-si (KR); Min-suk SEO, Suwon-si (KR); Jong-po LEE, Hwaseong-si (KR)

(21) Appl. No.: 14/876,112

(22) Filed: Oct. 6, 2015

(30) Foreign Application Priority Data
Oct. 7, 2014 (KR) 10-2014-0134888

(51) Int. Cl. H02J 7/00

(52) U.S. Cl. CPC H02J 7/007; H02J 7/0045; H02J 2007/0096

(57) ABSTRACT

An electronic apparatus and a controlling method thereof are provided. The electronic apparatus includes an interface configured to connect an external apparatus and a controller configured to determine a type of the external apparatus connected to the interface, and in response to a mode of the electronic apparatus being converted to a standby mode, to control power of the interface based on the determined type of the external apparatus.

### CROSS-REFERENCE TO RELATED APPLICATIONS

This application is based on and claims priority under 35 U.S.C. §119 to Korean Patent Application No. 10-2014-0134888, filed in the Korean Intellectual Property Office on Oct. 7, 2014, the disclosure of which is incorporated herein by reference in its entirety.

### BACKGROUND

1. Field

Aspects of the example embodiments relate to an electronic apparatus and a controlling method thereof, and for example, to an electronic apparatus which controls the power of an interface according to the type of connection apparatus and a controlling method thereof

2. Description of Related Art

Recently, the number of technologies to reduce power consumption and expedite the booting speed of devices has been increasing.

Normal booting refers to the operation of turning off and then turning on the power so that various application programs of a system can operate while a normal operating system is booted and executed.

Meanwhile, a recent electronic apparatus may provide a standby mode such as a suspend to RAM mode and an instant on mode where transition to an initialized state is possible within seconds of turning on a system while reducing power consumption, so as to be ready to perform functions of the system immediately.

In addition, an electronic apparatus may be connected to an external apparatus through an interface in order to make use of other various functions in addition to its original functions.

In the above-described standby mode, the power is supplied to only a minimum number of elements and is not supplied to the remaining elements. Thus, in general, the power of an interface which is used to connect an external apparatus is turned off in the standby mode.

However, as the number of various external apparatuses which are connectable to an electronic apparatus has been increasing, there is a need to control the power of an interface selectively even in the standby mode.

### SUMMARY

An aspect of the example embodiments relates to an electronic apparatus which may control a power supply based on the type of external apparatus connected to the electronic apparatus even in a standby mode and a controlling method thereof

According to an example embodiment, an electronic apparatus is provided including an interface configured to connect an external apparatus and a controller configured to determine the type of external apparatus connected to the interface, and in response to a mode of the electronic apparatus being converted to a standby mode, to control power of the interface based on the determined type of external apparatus.

The controller may include a sub controller configured to control power of the interface during the standby mode and a main controller configured to determine a type of the external apparatus, and in response to a mode of the electronic apparatus being converted to a standby mode, to control the sub controller to control power of the interface based on the determined type of the external apparatus.

The main controller, in response to determining that the external apparatus is an independent electronic apparatus and the electronic apparatus being converted to a standby mode, may be configured to transfer a signal for supplying power to the interface to the sub controller and to turn off power of the main controller, and the sub controller may be configured to control the electronic apparatus to turn on power of the interface based on the signal received from the main controller.

The main controller, in response to determining that the external apparatus is a dongle of a hardware type to serve as an Internet AP and the electronic apparatus being converted to a standby mode, may be configured to transfer a signal for supplying power to the interface to the sub controller and to turn off the main controller, and the sub controller may be configured to control the electronic apparatus to turn on power of the interface based on the signal received from the main controller.

The main controller, in response to determining that the external apparatus is a dongle of a software type to serve as an Internet AP, may be configured to control the electronic apparatus to turn on power of elements of the electronic apparatus so that the electronic apparatus is not converted to a standby mode.

The main controller, in response to determining that the external apparatus is a storage medium and the electronic apparatus being converted to a standby mode, may be configured to transfer a signal for not supplying power to the interface to the sub controller and to turn off power of the main controller, and the sub controller may be configured to control the electronic apparatus to turn off power of the interface based on the signal received from the main controller.

The sub controller, in response to detecting a connection to the external apparatus through the interface while a standby mode where power of the main controller is turned off is maintained, may apply power to the main controller.

The apparatus may further include an input unit, and the sub controller, in response to detecting a connection to the external apparatus through the interface and a command to turn on power of the electronic apparatus being input through the input unit, may be configured to apply power to elements of the electronic apparatus including the main controller.

According to an example embodiment, a method of controlling an electronic apparatus is provided including connecting the electronic apparatus to an external apparatus, determining a type of the external apparatus connected to the interface, and in response to a mode of the electronic apparatus being converted to a standby mode, controlling power of the interface based on the determined type of the external apparatus.

Determining may include determining a type of the external apparatus, and the controlling may include, in response to a mode of the electronic apparatus being converted to a standby mode, controlling a sub controller to control power of the interface based on the determined type of the external apparatus.

Controlling may include, in response to determining that the external apparatus is an independent electronic apparatus and the electronic apparatus being converted to a standby mode, transferring a signal for supplying power to the interface to the sub controller by the main controller, turning off power of the main controller, and controlling the electronic apparatus to turn on power of the interface based on the signal received from the main controller by the sub controller.

Controlling may include, in response to determining that the external apparatus is a dongle of a hardware type to serve as an Internet AP and the electronic apparatus being converted to a standby mode, transferring a signal for supplying power to the interface to the sub controller by the main controller, turning off the main controller, and controlling the electronic apparatus to turn on power of the interface based on the signal received from the main controller by the sub controller.

Controlling may include, in response to determining that the external apparatus is a dongle of a software type to serve as an Internet AP, controlling the electronic apparatus to turn on power of elements of the electronic apparatus so that the electronic apparatus is not converted to a standby mode.

Controlling may include, in response to determining that the external apparatus is a storage medium and the electronic apparatus being converted to a standby mode, transferring a signal for not supplying power to the interface to the sub controller by the main controller, turning off power of the main controller, and controlling the electronic apparatus to turn off power of the interface based on the signal received from the main controller by the sub controller.

The method may further include, in response to detecting a connection to the external apparatus through the interface while a standby mode in which power of the main controller is turned off is maintained, applying power to the main controller by the sub controller.

The method may further include, in response to detecting a connection to the external apparatus through the interface and a command to turn on power of the electronic apparatus being input through the input unit, applying power to the main controller by the sub controller.

According to the various example embodiments, even if an electronic apparatus is in a standby mode, the electronic apparatus may control a power supply depending on the type of a connected external apparatus.

### BRIEF DESCRIPTION OF THE DRAWINGS

The above and/or other aspects and advantages of the example embodiments will become more apparent from the following detailed description taken in conjunction with the accompanying drawings, in which like reference numerals refer to like elements, and wherein:

FIG. 1 is a view illustrating an apparatus system according to an example embodiment;

FIG. 2 is a block diagram illustrating a configuration of an electronic apparatus according to an example embodiment;

FIGS. 3A and 3B are block diagrams illustrating a configuration of an electronic apparatus;

FIGS. 4A to 4C are views provided to illustrate a method of controlling the power of an interface based on the type of external apparatuses when the electronic apparatus is in a standby mode;

FIGS. 5A and 5B are views illustrating a UI before an electronic apparatus enters a standby mode; and

FIGS. 6 to 8 are flowcharts illustrating a method of controlling an electronic apparatus according to various example embodiments.

### DETAILED DESCRIPTION

The example embodiments may vary, and may be provided in different example embodiments. Specific example embodiments will be described with reference to accompanying drawings and detailed explanation. However, this does not necessarily limit the scope of the example embodiments to a specific embodiment form. Instead, modifications, equivalents and replacements of the disclosed embodiments and technical scope of this specification may be employed. While describing example embodiments, if it is determined that the specific description regarding a known technology might obscure the gist of the invention, the specific description is omitted.

In the disclosure, relational terms such as first and second, and the like, may be used to distinguish one entity from another entity, without necessarily implying any actual relationship or order between such entities.

The terms used in the following description are provided to explain example embodiments and are not intended to limit the scope. A singular term includes a plural form unless it is intentionally written that way. The terms, “include”, “comprise”, “is configured to”, etc. of the description are used to indicate that there are features, numbers, steps, operations, elements, parts or combination thereof, and they should not exclude the possibilities of combination or addition of one or more features, numbers, steps, operations, elements, parts or combination thereof

In an example embodiment, ‘a module’ or ‘a unit’ performs at least one function or operation, and may be realized as hardware, software, or combination thereof. In addition, a plurality of ‘modules’ or a plurality of ‘units’ may be integrated into at least one module and may be realized as at least one processor (not shown) except for ‘modules’ or ‘units’ that should be realized in a specific hardware.

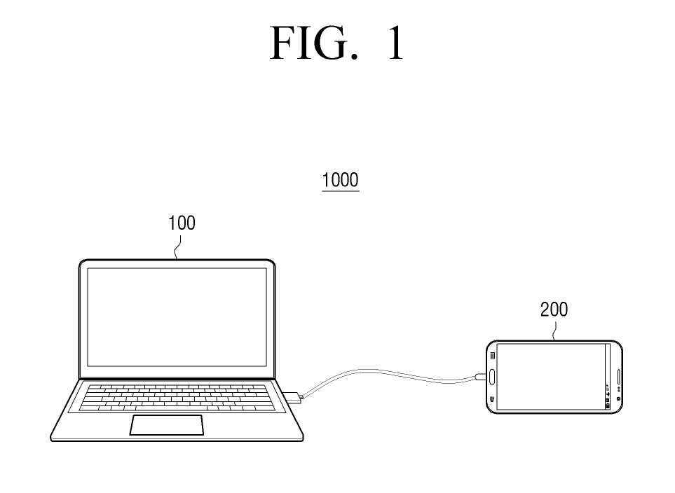

FIG. 1 is a view illustrating an apparatus system 1000 according to an example embodiment. As illustrated in FIG. 1, the apparatus system 1000 includes an electronic apparatus 100 and an external apparatus 200. FIG. 1 illustrates the electronic apparatus 100 which is realized, for example, as a notebook PC, but this is only an example. The electronic apparatus 100 may, for example, be realized as various electronic apparatuses such as TV, mobile phone, smart phone, PDP, PDA, tablet PC, home theater, digital camera, refrigerator, watching machine, etc.

In addition, FIG. 1 illustrates that the external apparatus 200 connected to the electronic apparatus 100 through an interface may, for example, be a mobile phone such as a smart phone, but this is only an example. The external apparatus 200 may be realized as various apparatuses such as TV which is the same kind as the electronic apparatus 100 or different kind from the electronic apparatus, such as, for example, a mobile phone, smart phone, PDP, PDA, tablet PC, home theater, digital camera, refrigerator, watching machine, storage medium, wireless dongle, etc.

Meanwhile, according to an example embodiment, the electronic apparatus 100 included in the apparatus system 1000 of FIG. 1 may determine the type of the external apparatus 200 and control the power of an interface based on the determined type of the external apparatus 200. Example configurations of the electronic apparatus 100 will be described below.

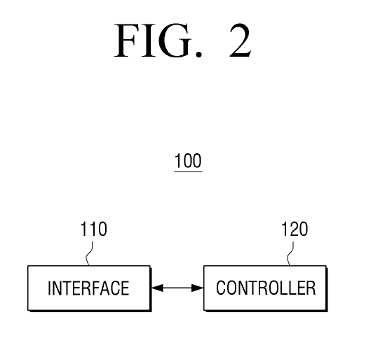

FIG. 2 is a block diagram illustrating a configuration of the electronic apparatus 100 according to an example embodiment. As illustrated in FIG. 2, the electronic apparatus 100 may include an interface 110 and a controller 120.

The interface 110 may, for example, be an element to connect the electronic apparatus 100 with the external apparatus 200. For example, the interface 110 may be realized in the form which makes it easier for the external apparatus 200 to be attached to or detached from the electronic apparatus 100 without any fixation device.

For example, the interface 110 may be realized as a USB interface. For example, the electronic apparatus 100 may include a USB port which is connectable to a USB connector on one side. The external apparatus 200 including a USB connector or the USB connector of the external apparatus 200 which is connected to a USB cable including a USB connector may be connected to a USB port.

The interface 110 may further include a power switch (not illustrated). Accordingly, it may be determined whether to apply power to the external apparatus 200 connected to the interface 110 depending on whether power is applied to the power switch.

The controller 120 may be configured to control the overall operations of the electronic apparatus 100. For example, the controller 120 may be configured to determine the type of the external apparatus 200 connected to the interface 110. If the mode of the electronic apparatus 100 is in or converted to a standby mode, the power of the interface 110 may be controlled based on the determined type of the external apparatus.

The standby mode refers to mode where the power of some elements included in the electronic apparatus 100 is turned off in order to reduce power consumption of the electronic apparatus 100. In other words, in the standby mode, the execution state of the electronic apparatus 100 at the time when the power of the electronic apparatus 100 is turned off is stored in a volatile memory, and the power of the configuration of the electronic apparatus 100 excluding micom, volatile memory, and Bluetooth module for receiving a control signal of a Bluetooth remote controller, etc. is turned off

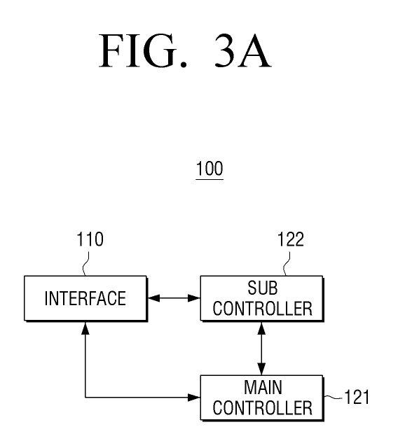

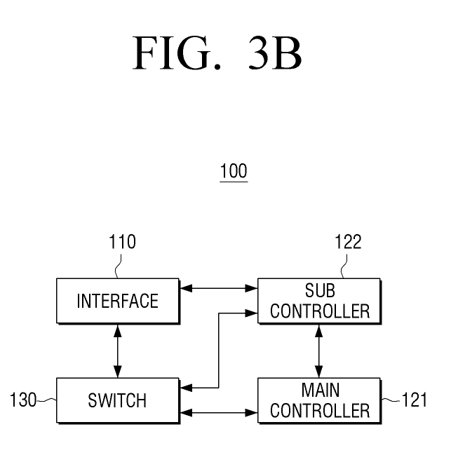

Meanwhile, as illustrated in FIG. 3A, the controller 120 may include a main controller 121 and a sub controller 122 according to an example embodiment.

The main controller 121 may be configured to determine the type of the external apparatus 200, and if the mode of the electronic apparatus 100 is converted to a standby mode, may be configured to control the sub controller 122 to control the power of the interface based on the determined type of the external apparatus 200. The sub controller 122 may be configured to control the power of the interface 110 during a standby mode.

For example, if the main controller 121 determines that an external apparatus is an independent electronic apparatus and the electronic apparatus 100 is converted to a standby mode, the main controller 121 may be configured to transfer a signal for supplying power to the interface 110 to the sub controller 122. As the mode is converted to a standby mode, the main controller 121 may be configured to turn off its power. The independent electronic apparatus may include a display, a communicator, a controller, etc., and refers to any type of electronic apparatuses which can operate independently without being connected to the electronic apparatus 100. For example, the independent electronic apparatus may include an electronic apparatus which can be used independently such as smart phone, tablet PC, notebook PC, TV, etc.

The sub controller 122 may be configured to control the electronic apparatus to turn on the power of the interface 110 based on the signal received from the main controller 121.

Meanwhile, if the main controller 121 determines that the external apparatus 200 is a dongle of a hardware type for serving as an Internet AP and the electronic apparatus 100 is converted to a standby mode, the main controller 121 may be configured to transfer a signal for supplying power to the interface 110 to the sub controller 122. As the mode is converted to a standby mode, the main controller 121 may turn off its power.

The sub controller 122 may be configured to control the electronic apparatus to turn on the power of the interface 110 based on the signal received from the main controller 121.

If the main controller 121 determines that the external apparatus 200 is a dongle of a software type for serving as an Internet AP, the main controller 121 may be configured to control the electronic apparatus to turn on the power of the electronic apparatus 100 so that the electronic apparatus 100 is not converted to a standby mode.

For example, a software-type dongle requires downloading of a driver and firmware and thus, the main controller 121 may be configured to control the electronic apparatus 100 including the controller 121 and the interface 110 to maintain a power-on state and the electronic apparatus 100 is not converted to a standby mode.

In other words, if the external apparatus 200 is determined to be a software-type dongle, the electronic apparatus 100 is controlled to not be converted to a standby mode even if a command to convert the electronic apparatus 100 to a standby mode is input or a command regarding the electronic apparatus 200 is not input for a predetermined time.

Meanwhile, if the main controller 121 determines that the external apparatus 200 is a storage medium and the electronic apparatus 100 is converted to a standby mode, the main controller 121 may transfer a signal for not supplying power to the interface 110 to the sub controller 122. As the mode is converted to a standby mode, the main controller 121 may turn off its power.

The sub controller 122 may be configured to control the electronic apparatus to turn off the power of the interface 110 based on the signal received from the main controller 121.

The electronic apparatus 100 may further include an input unit (not illustrated). Accordingly, if the sub controller 122 detects a connection of the external apparatus 200 through the interface 110 and a command to turn on the power of the electronic apparatus 100 is input through the input unit while the standby mode where the power of the main controller 121 is turned off is maintained, the sub controller 122 may apply power to the main controller 121.

Meanwhile, as illustrated in FIG. 3B, the electronic apparatus 100 may further include a switch 130 according to an example embodiment. If a connection of the external apparatus 200 is detected through the interface 110 while the electronic apparatus is in the standby mode where the power of the main controller 121 is turned off is maintained, the sub controller 122 may be configured to change the connection path of the switch 130 to the main controller 121 and apply power to the main controller 121.

Thus, according to the above-described method, the main controller 121 where power is applied may determine the type of the external apparatus 200 and control the power of the main controller 121 and the interface 110.

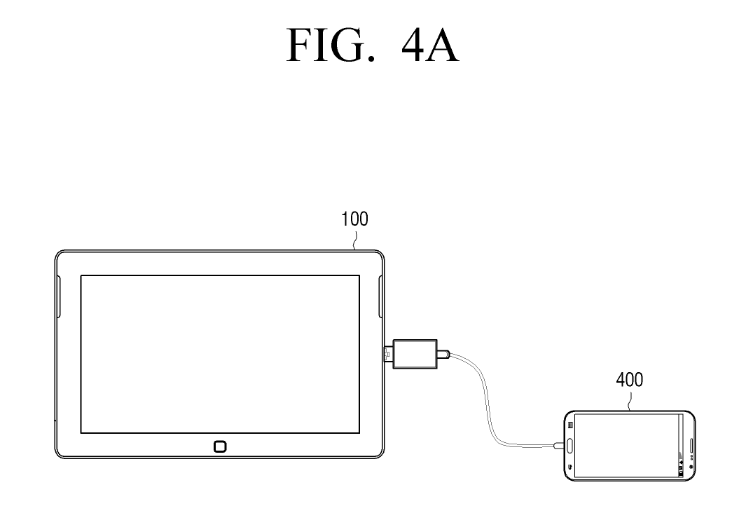

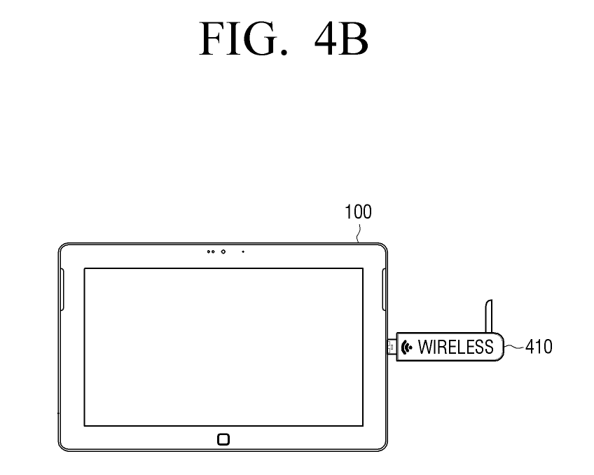

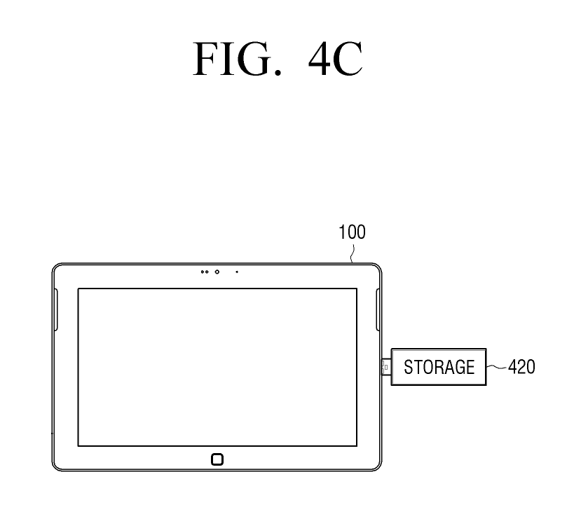

A method of controlling the power of the interface 110 based on the type of the external apparatus 200 in a standby mode where the power of the main controller 121 is turned off will be described in detail with reference to FIGS. 4A to 4C.

FIG. 4A is a view illustrating an example embodiment where, for example, a smart phone 400, as the external apparatus 200, is connected to the interface 110 of the electronic apparatus 100 which is realized as, for example, a tablet PC. FIG. 4A illustrates the smart phone 400 as an example independent electronic apparatus, but this is only an example. The independent electronic apparatus may be realized as various types of electronic apparatuses which may operate without being connected to the electronic apparatus 100, such as TV, tablet PC, notebook PC, PDA, PDP, etc.

The electronic apparatus 100 may maintain the state of a standby mode where the power of the main controller 121 is turned off and power is applied only to some elements including the sub controller 122 in order to reduce power consumption.

If a command to enter a standby mode is input or a command regarding the electronic apparatus 100 is not input for a predetermined time, the electronic apparatus 100 may convert to a standby mode by storing the execution state of the electronic apparatus 100 in a volatile memory such as a RAM and turning off almost all elements including the main controller 121 except for some of the elements such as the sub controller 122 and, for example, a Bluetooth module.

If the electronic apparatus 100 is converted to a standby mode, the power of the interface 110 is generally cut off. Accordingly, when the electronic apparatus 100 is converted to a standby mode, power is not applied or supplied to the external apparatus 200 which is connected to the interface 110.

If a user wishes to use information, applications, etc. stored in the smart phone 400 through the electronic apparatus 100 or recharge a battery of the smart phone 400, the smart phone 400 may be connected to the electronic apparatus 100 as illustrated in FIG. 4A.

However, if the electronic apparatus 100 is converted to a standby mode and thus, the power of the interface 110 is cut off when the user connects the smart phone 400 to the electronic apparatus 100 to recharge the battery of the smart phone 400, the user cannot recharge the smart phone 400. In other words, in the past the user had to control the electronic apparatus 100 not to enter a standby mode in order to recharge the smart phone 400 even if the electronic apparatus 100 is not in use, which may cause inconvenience.

Accordingly, the main controller 121 may be configured to determine the type of an external apparatus which is connected to the interface 110 before entering a standby mode. If the external apparatus is an independent electronic apparatus such as the smart phone 400, the electronic apparatus 100 may receive driver information via cable or wirelessly when the smart phone 400 is connected for the first time and store the information. In other words, the main controller 121 may be configured to determine, based on the received information, whether an apparatus such as the smart phone 400 is an independent electronic apparatus which requires power even when the electronic apparatus 100 is in a standby mode.

If it is determined that the external apparatus connected to the interface 110 is the smart phone 400, the main controller 121 may transfer a signal for maintaining the power-on state of the interface 110 to the sub controller 122. In addition, in order to enter a standby mode, the main controller 121 may turn off its power. The sub controller 121 may maintain the power-on state of the interface 110 based on the signal received from the main controller 121.

Accordingly, even in a standby mode where the power of the main controller 121 is turned off, power can be applied to the smart phone 400 connected to the interface 110.

Meanwhile, if the smart phone 400 is connected through the interface 110 which is, for example, a USB port while the electronic apparatus 100 is in a standby mode, the sub controller 122 may apply power to the main controller 121, and the main controller 121 may determine whether to maintain the power of the interface 110 as described above.

For example, if a USB connector connected to the smart phone 400 is connected to a USB port of the electronic apparatus 100, the DP line of the USB connector becomes high, and the sub controller 122 may detect the connection of the smart phone 400.

In other words, as a connection path of a switch 130 connects the USB port and the sub controller 122, the sub controller 122 may detect a high signal of the DP line of the USB connector.

The sub controller 122 which detects the connection of the smart phone 400 may change the connection path of the switch 130 so that the USB port is connected to the main controller 121. In addition, the sub controller 122 may be configured to apply power to the main controller 121 of which power has been turned off

Accordingly, the main controller 121 where power is applied may be configured to determine that the smart phone 400 is an independent electronic apparatus using the above-described method. The main controller 121 may be configured to turn off its power and transfer a signal for maintaining the power-on state of the interface 110 to the sub controller 122.

Meanwhile, when the electronic apparatus 100 does not include the switch 130, if the smart phone 400 is connected through the interface 110 which is a USB port while the electronic apparatus 100 is in a standby mode and a command to turn on the power of the electronic apparatus 100 is input, the sub controller 122 may be configured to apply power to the main controller 121 and the main controller 121 may be configured to determine whether to maintain the power of the interface 110 as described above.

If it is determined that the smart phone 400 is an appropriate independent electronic apparatus to be supplied with power in a standby mode, the main controller 121 may be configured to transfer a signal for turning on the power of the interface 110 to the sub controller 122 when entering the standby mode.

If the electronic apparatus 100 is converted to a standby mode based on a command or if the electronic apparatus 100 is converted to a standby mode as a command is not input for a predetermined time, the sub controller 122 may be configured to control the electronic apparatus to apply power to the interface 110 based on the signal received from the main controller 121.

Meanwhile, as illustrated in FIG. 4B, if the external apparatus is a wireless dongle 410, the power of the interface 110 may be controlled differently from when the external apparatus is the smart phone 400.

The wireless dongle 410 is, for example, a hardware-type dongle for serving as an Internet AP and the electronic apparatus 100 is converted to a standby mode, only the wireless dongle 410 requires power and thus, the main controller 121 may be configured to operate in the different manner as in the example embodiment regarding the smart phone 400.

Meanwhile, if the wireless dongle 410 is, for example, a software-type dongle for serving as an Internet AP and the electronic apparatus 100 is converted to a standby mode, the software wireless dongle 410 requires downloading of driver/firmware and thus, the main controller 121 may be configured to control the electronic apparatus 100 not to enter a standby mode.

In other words, as the downloading of driver/firmware is performed in the main controller 121, the main controller 121 may control the electronic apparatus 100 not to enter a standby mode where the power of the main controller 121 is turned off

Meanwhile, as illustrated in FIG. 4C, if the external apparatus is a storage medium 420, the main controller 121 may be configured to control the electronic apparatus 100 to turn off the power of the interface 110 when the electronic apparatus 100 enters a standby mode.

In many cases, when the storage medium 420 is connected through the interface 110 of the electronic apparatus 100, the electronic apparatus 100 reads the contents stored in the storage medium 420 and display or provide the contents to a user. Accordingly, in many cases, when the electronic apparatus 100 enters a standby mode and thus, the elements such as a display are turned off, the storage medium 420 is not needed.

Accordingly, when it is determined that the external apparatus is a storage medium 420, if the electronic apparatus 100 is converted to a standby mode, the main controller 121 may be configured to transfer a signal for turning off the power of the interface 110 to the sub controller 122.

If the electronic apparatus 100 is converted to a standby mode and thus, the power of the main controller 121 is turned off, the sub controller 122 may be configured to turn off the power of the interface 110 based on the signal received from the main controller 121.

When the external apparatus is a storage medium 420, the electronic apparatus 100 may also receive driver information via cable or wirelessly when the storage medium 420 is connected for the first time and store the apparatus information.

However, if the external apparatus is a storage medium 420, it is merely an example that the main controller 121 may be configured to determine the storage medium 420 as an apparatus which does not require power supply in a standby mode. Alternatively, the main controller 121 may determine the storage medium 420 as an apparatus which requires power supply in a standby mode based on the received driver information.

For example, if the storage medium 420 is an apparatus which requires recharging or includes a separate display function, the main controller 121 may be configured to transmit a signal for applying power to the interface 110 even in a standby mode to the sub controller 122.

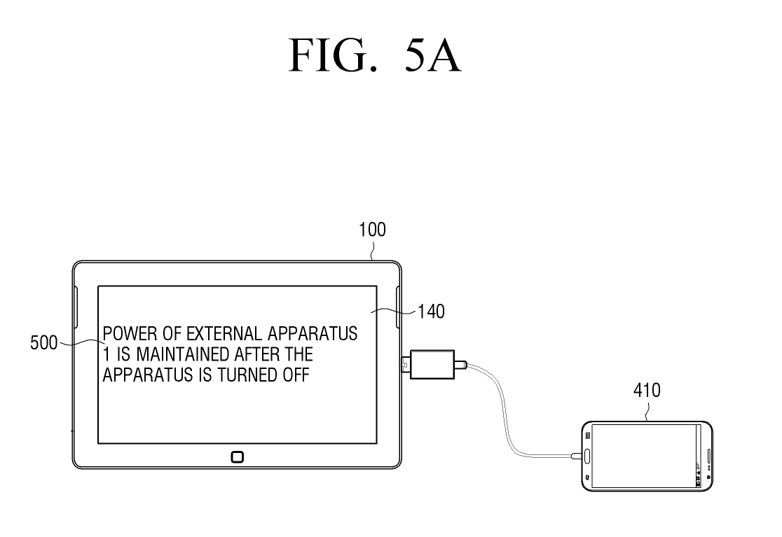

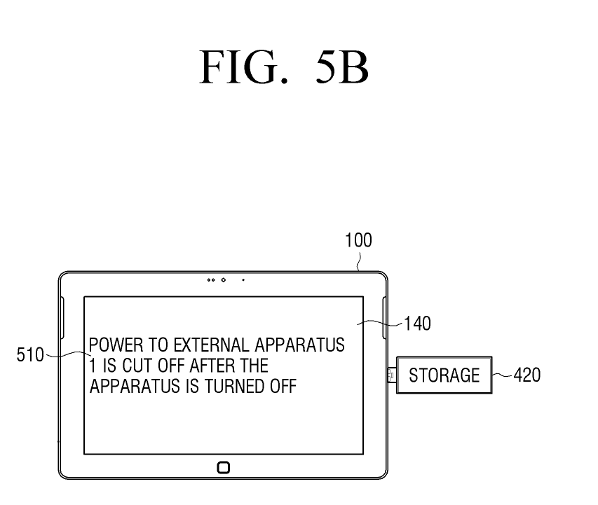

FIGS. 5A and 5B are views illustrating an example embodiment where a UI is displayed before the electronic apparatus 100 enters a standby mode.

As illustrated in FIGS. 5A and 5B, if the electronic apparatus 100 includes a display 140, the electronic apparatus 100 may display a UI for informing a user of whether to maintain the power of the interface 110 in a standby mode through the display 140.

As described above, if the external apparatus 200 is an electronic apparatus which can be used independently, such as, for example, the smart phone 410, the electronic apparatus 100 may maintain the power supply of the interface 110 even if the mode of electronic apparatus 100 is converted to a standby mode.

Accordingly, the electronic apparatus 100 may display a message, such as, for example, ‘the power of external apparatus 1 is maintained after the apparatus is turned off’ through the display 140. Based on the message, ‘the power of external apparatus 1 is maintained after the apparatus is turned off’, a user may predict that power will be continuously supplied to, for example, the smart phone 410 which is connected to the electronic apparatus 100.

Meanwhile, as described above, if the external apparatus 200 is not an apparatus which can be used independently, such as a storage 420, the electronic apparatus 100 may turn off the power of the interface 110 when the mode of the electronic apparatus 100 is converted to a standby mode.

Accordingly, the electronic apparatus 100 may display a message 510, ‘the power to external apparatus 1 is cut off after the apparatus is turned off’, through the display 140.

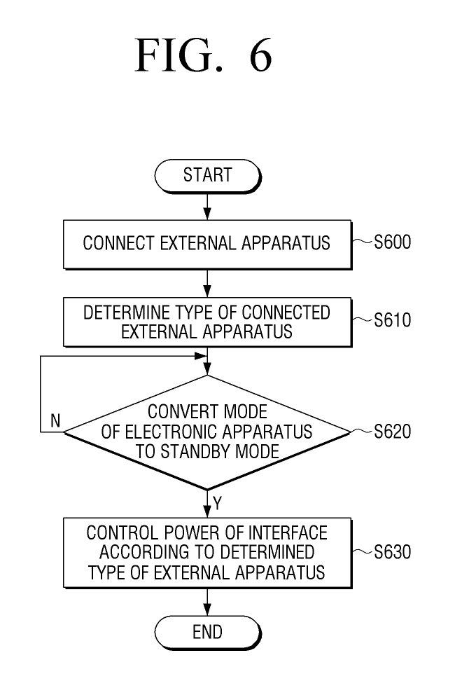

FIG. 6 is a flowchart illustrating a method of controlling the electronic apparatus 100 according to an example embodiment.

First of all, if the electronic apparatus 100 is connected to the external apparatus 200 through an interface (S600), the type of the connected external apparatus 200 is determined (S610). In other words, the electronic apparatus 100 may receive driver information via cable or wirelessly when the external apparatus 200 is connected for the first time and store the information regarding the external apparatus 200. Based on the received information regarding the external apparatus 200, the electronic apparatus 100 determines whether the external apparatus 200 is an apparatus which requires power in a standby mode.

When the mode of the electronic apparatus 100 is converted to a standby mode (S620-Y), the electronic apparatus 100 controls the power of the interface based on the determined type of the external apparatus (S630).

In other words, if the external apparatus 200 is an independently-usable electronic apparatus such as smart phone, notebook PC, tablet PC, PDA, PDP, etc., or a hardware-type wireless dongle, the electronic apparatus 100 may determine that the external apparatus 200 is an apparatus which requires power supply in a standby mode. Accordingly, even if the electronic apparatus 100 is converted to a standby mode and thus, almost all elements including the main controller are turned off, power can be applied to the interface under the control of the sub controller.

Meanwhile, if the external apparatus 200 is an apparatus which has little possibility of being used independently, such as a storage medium, the electronic apparatus 100 may determine that the external apparatus 200 does not require power in a standby mode. Accordingly, if the electronic apparatus 100 is converted to a standby mode, the power of the interface may also be turned off under the control of the sub controller.

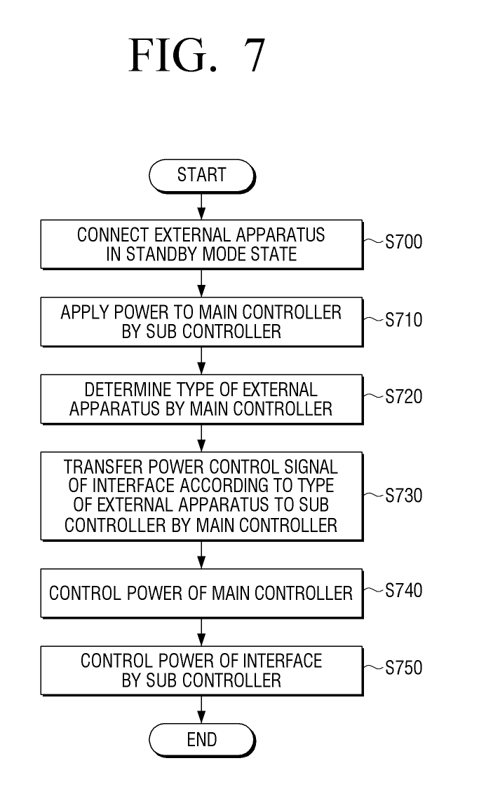

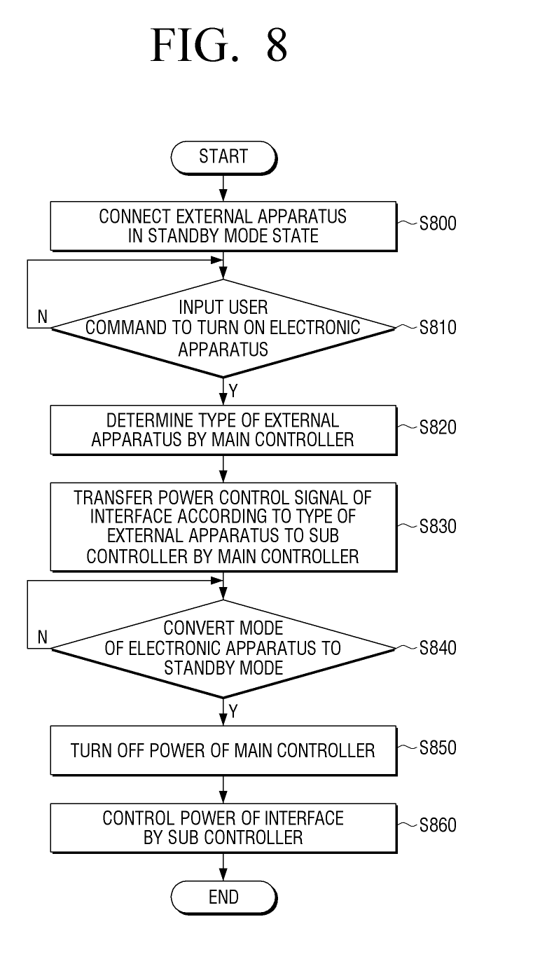

FIGS. 7 and 8 are flowcharts illustrating a method of controlling the electronic apparatus 100 when a connection with the external apparatus 200 is connected while the electronic apparatus 100 is in a standby mode.

As illustrated in FIG. 7, if the external apparatus 200 is connected when the electronic apparatus is in a standby mode (S700), the electronic apparatus 100 applies power to the main controller under the control of the sub controller (S710). The main controller where the power is applied determines the type of the external apparatus 200 (S720). The method of determining the type of the connected external apparatus 200 by the main controller is the same as the corresponding method which has been described above.

The main controller transfers a power control signal of the interface based on the type of the external apparatus to the sub controller (S730). The power of the main controller is controlled (S740). The sub controller controls the power of the interface (S760).

For example, based on the determination result, the sub controller may receive a turn-on or turn-off signal of the interface. When the power of the main controller is turned off, the sub controller may control the power of the interface based on the signal received from the main controller.

Meanwhile, in FIG. 8, if the external apparatus is connected in a standby mode (S800) and a command, such as, for example, a user command to turn on the power of the electronic apparatus is input (5810-Y), the electronic apparatus 100 turns on the power of elements including the power of the main controller based on the user command.

The main controller where the power is applied determines the type of the connected external apparatus (S820). The method of determining the type of the connected external apparatus 200 by the main controller is the same as the corresponding method which has been described above.

The main controller transfers a power control signal of the interface based on the type of the external apparatus to the sub controller (S830). When the mode of the electronic apparatus 100 is converted to a standby mode (S840-Y), the power of the main controller is controlled (S750). In other words, if a user command to convert the mode of the electronic apparatus 100 to a standby mode is input, or a user command regarding the electronic apparatus 100 is not input for a predetermined time, the mode of the electronic apparatus 100 is converted to a standby mode, and the power of the main controller is turned off

When the mode of the electronic apparatus 100 is converted to a standby mode, the power of the interface is controlled by the sub controller (S860). For example, based on the determination result of the main controller, the sub controller a turn-on or turn-off signal of the interface. When the power of the main controller is turned off, the sub controller may control the power of the interface based on the signal received from the main controller.

The method of controlling an electronic apparatus according to the above-described various example embodiments may be coded as software and stored in a non-transitory readable medium which may be mounted and used in various apparatuses.

The non-transitory recordable medium refers to a medium which may store data semi-permanently rather than storing data for a short time, such as register, cache, memory, etc. and is readable by an apparatus. For example, the above-described various applications and programs may be stored and provided in a non-transitory recordable medium such as CD, DVD, hard disk, Blu-ray disk, USB, memory card, ROM, etc.

The foregoing example embodiments and advantages are merely examples and are not to be construed as limiting the present invention. The examples and disclosure can be readily applied to other types of apparatuses. Also, the description of the example embodiments is intended to be illustrative, and not to limit the scope of the claims, and the many alternatives, modifications, and variations that will be apparent to those skilled in the art.

What is claimed is:

1. An electronic apparatus, comprising:
an interface configured to connect an external apparatus to the electronic apparatus; and
a controller configured to determine a type of the external apparatus connected to the interface, and to control power of the interface based on the determined type of the external apparatus in response to a mode of the electronic apparatus being converted to a standby mode.

2. The apparatus as claimed in claim 1, wherein the controller comprises:
a sub controller configured to control power of the interface during the standby mode; and
a main controller configured to determine a type of the external apparatus, and to control the sub controller to control power of the interface based on the determined type of the external apparatus in response to a mode of the electronic apparatus being converted to a standby mode.

3. The apparatus as claimed in claim 2, wherein the main controller is configured to transfer a signal for supplying power to the interface to the sub controller and to turn off power of the main controller in response to determining that the external apparatus is an independent electronic apparatus and the electronic apparatus being converted to a standby mode,
wherein the sub controller is configured to control the electronic apparatus to turn on power of the interface based on the signal received from the main controller.

4. The apparatus as claimed in claim 2, wherein the main controller is configured to transfer a signal for supplying power to the interface to the sub controller and to turn off the main controller in response to determining that the external apparatus is a dongle of a hardware type and the electronic apparatus being converted to a standby mode,
wherein the sub controller is configured to control the electronic apparatus to turn on power of the interface based on the signal received from the main controller.

5. The apparatus as claimed in claim 2, wherein the main controller is configured to control the electronic apparatus to turn on power of elements of the electronic apparatus so that the electronic apparatus is not converted to a standby mode in response to determining that the external apparatus is a dongle of a software type.

6. The apparatus as claimed in claim 2, wherein the main controller is configured to transfer a signal for not supplying power to the interface to the sub controller and to turn off power of the main controller in response to determining that the external apparatus is a storage medium and the electronic apparatus being converted to a standby mode,
wherein the sub controller is configured to control the electronic apparatus to turn off power of the interface based on the signal received from the main controller.

7. The apparatus as claimed in claim 2, wherein the sub controller is configured to apply power to the main controller in response to detecting a connection to the external apparatus through the interface while the electronic apparatus is in a standby mode where power of the main controller is turned off.

8. The apparatus as claimed in claim 2, further comprising:
an input unit,
wherein the sub controller is configured to apply power to elements of the electronic apparatus including the main controller in response to detecting a connection to the external apparatus through the interface and a command to turn on power of the electronic apparatus being input through the input unit.

9. A method of controlling an electronic apparatus, comprising:
connecting the electronic apparatus to an external apparatus;
determining a type of the external apparatus connected to the interface; and
controlling power of the interface based on the determined type of the external apparatus in response to a mode of the electronic apparatus being converted to a standby mode.

10. The method as claimed in claim 9, wherein determining comprises determining a type of the external apparatus,
wherein controlling comprises, controlling the sub controller to control power of the interface based on the determined type of the external apparatus in response to a mode of the electronic apparatus being converted to a standby mode.

11. The method as claimed in claim 10, wherein controlling comprises, transferring a signal for supplying power to the interface to the sub controller by the main controller in response to determining that the external apparatus is an independent electronic apparatus and the electronic apparatus being converted to a standby mode;
turning off power of the main controller; and
controlling the electronic apparatus to turn on power of the interface based on the signal received from the main controller by the sub controller.

12. The method as claimed in claim 10, wherein controlling comprises, transferring a signal for supplying power to the interface to the sub controller by the main controller in response to determining that the external apparatus is a dongle in a hardware type and the electronic apparatus being converted to a standby mode;
turning off the main controller; and
controlling the electronic apparatus to turn on power of the interface based on the signal received from the main controller by the sub controller.

13. The method as claimed in claim 10, wherein controlling comprises, controlling the electronic apparatus to turn on power of elements of the electronic apparatus so that the electronic apparatus is not converted to a standby mode in response to determining that the external apparatus is a dongle of a software type.

14. The method as claimed in claim 10, wherein controlling comprises, transferring a signal for not supplying power to the interface to the sub controller by the main controller in response to determining that the external apparatus is a storage medium and the electronic apparatus being converted to a standby mode;
turning off power of the main controller; and
controlling the electronic apparatus to turn off power of the interface based on the signal received from the main controller by the sub controller.

15. The method as claimed in claim 9, further comprising:
applying power to the main controller by the sub controller in response to detecting a connection to the external apparatus through the interface while a standby mode where power of the main controller is turned off is maintained.

16. The method as claimed in claim 9, further comprising:
applying power to the main controller by the sub controller in response to detecting a connection to the external apparatus through the interface and a user command to turn on power of the electronic apparatus being input through the input unit.

17. The apparatus as claimed in claim 4, wherein the dongle of the hardware type serves as an Internet AP.

18. The apparatus as claimed in claim 5, wherein the dongle of the software type serves as an Internet AP.

19. The method as claimed in claim 12, wherein the dongle of the hardware type serves as an Internet AP.

20. The method as claimed in claim 13, wherein the dongle of the software type serves as an Internet AP.
